(19) United States
(12) Patent Application Publication
(10) Pub. No.: US 2004/0225423 A1
(43) Pub. Date: Nov. 11, 2004

(54) Determination of operational parameters of tires in vehicles from longitudinal stiffness and effective tire radius

(76) Inventors: Christopher R. Carlson, Menlo Park, CA (US); Joseph C. Gerdes, Los Altos, CA (US)

Correspondence Address: LUMEN INTELLECTUAL PROPERTY SERVICES, INC., 2345 YALE STREET, 2ND FLOOR, PALO ALTO, CA, 94306, US

(21) Appl. No.: 10/703,095

(22) Filed: Nov. 5, 2003

Related U.S. Application Data
(63) Continuation-in-part of application No. 10/434,396, filed on May 7, 2003, now abandoned.

(51) Int. Cl. G01M 17/00; G06F 7/00

(52) U.S. Cl. 701/36; 701/29

(57) ABSTRACT

An apparatus and method for determining operational parameters of a tire in terrestrial vehicles are described. Velocity of a vehicle is determined, for example, by using the global positioning system. A free-rolling radius of a free-rolling wheel is determined from the velocity and angular velocity of the free-rolling wheel, which is determined with a wheel sensing unit when angular acceleration is negligible. Absolute velocity and acceleration are determined from the free-rolling radius and the angular velocity. Longitudinal stiffness and effective radius of the tire on a monitored wheel are determined. For a free-rolling wheel, these parameters may be determined separately. For a driven wheel, these parameters are determined simultaneously when the vehicle is accelerating using a nonlinear estimation algorithm. The resulting operational parameters of the tire, such as a tire pressure, temperature or wear, are determined accurately and on an absolute scale enabling real-time monitoring of performance of the tire.

### RELATED APPLICATIONS

This application is a continuation-in-part of U.S. patent application Ser. No. 10/434,396 filed on 7 May 2003.

### FIELD OF THE INVENTION

The present invention relates generally to methods for determining operational parameters including inflation pressure of tires in terrestrial vehicles by determining longitudinal stiffness Cₓ and effective tire radius R_{eff.} and to vehicles equipped to implement such methods.

### BACKGROUND OF THE INVENTION

Communications, shipping and transportation are just a few of the many sectors that rely heavily on vehicles driven on wheels with tires. Many operation parameters of these vehicles need to be controlled, monitored, supervised and communicated for a number of reasons not the least of which include vehicle control, safety and efficient driving. In particular, knowledge of the operation parameters of the tires themselves is very important to a driver of the vehicle as well as any person involved in maintenance or repair of the vehicle.

While tire operation parameters are quite important to both current vehicle control systems and proposed future systems, these parameters are subject to considerable variability and are difficult to estimate while driving. Among the many reasons is the unavailability of absolute vehicle velocity as well as various types of errors in the determination of real-time data about the state of the vehicle and its tires.

The prior art teaches numerous approaches to determining the states of a vehicle and its tires. For example, U.S. Pat. No. 6,549,842 describes a method and apparatus for determining an individual wheel surface coefficient of adhesion. This reference describes how to parameterize a complicated vehicle model with gradient-based parameter estimation schemes for the purpose of estimating both the cornering stiffness and longitudinal stiffness of vehicle tires. U.S. Pat. No. 6,508,102 teaches near-real time friction estimation for pre-emptive vehicle control by fully parameterizing a vehicle model to obtain cornering stiffness and longitudinal stiffness estimates. The model is parameterized by driving under nominal operation conditions and then compared with data during actual operation.

Unfortunately, the above references do not extend their teachings to determining operation parameters of tires such as tire pressure, wear, temperature and effective radius. In fact, it is the knowledge of these operation parameters of the tire that would be useful for control and monitoring purposes.

Several prior art references attempt to estimate, among other, tire operation parameters such as tire air pressure or its reduction. For example, U.S. patent application No. 2003/0051560 teaches to use the estimate of cornering stiffness to infer tire inflation pressure. The estimation uses a least squares fit. U.S. patent application No. 2002/0010537 teaches another estimation method that assumes longitudinal stiffness of the tire to be correlated with tire operation parameters such as tire wear and temperature as well as peak road friction. U.S. Pat. Nos. 6,064,936 and 6,060,983 teach the use of a relative slip of wheels to determine a relative inflation pressure decrease.

In fact, there are several distinct approaches to determining tire pressure. Approaches based on the wheel radius and its changes are described in U.S. Pat. Nos. 6,501,373, 6,407,661 and 6,388,568. Another approach based on wheel vibration spectrum, longitudinal stiffness dependence upon inflation pressure and longitudinal stiffness dependence upon peak road friction is taught in U.S. patent application No. 2002/0059826. Still another approach based on relative wheel velocity comparison is described in U.S. Pat. No. 6,420,966.

Unfortunately, these known approaches to estimating tire operation parameters including tire pressure suffer from a high noise level and hence poor accuracy. This inaccuracy is attributable to a number of causes including lack of sufficient data about the absolute velocity or position of the vehicle, inherently noisy estimation algorithms, lack of data on effective wheel radii and general errors associated with on-board inertial sensing apparatus.

Finally, U.S. Pat. No. 6,313,742 teaches a method and apparatus for wheel condition and load position sensing which can detect under-pressure tires. In fact, this teaching extends to determining operation parameters such as out-of-round tires, poor front wheel alignment and off-centerline loads. The method teaches to derive these from the wheel free-rolling radius of each tire. The teaching extends to taking relative measurements by relying on wheel speed as well as absolute measurements by relying on position data from the global positioning system (GPS). Unfortunately, reliance on GPS position data and on free-rolling radius of the tire to determine tire-operating parameters yields low sensitivity.

In fact, none of the prior art teachings determine the longitudinal stiffness and wheel effective radius on an absolute scale and hence suffer from associated limitations. Furthermore, the prior art does not teach how to simultaneously obtain the effective radius and longitudinal stiffness. In addition, the estimation algorithms used by prior art are limited by relatively high levels of noise. For these reasons and other reasons the prior art does not provide sufficiently accurate tire operation parameters such as tire pressure, temperature and wear.

### OBJECTS AND ADVANTAGES

In view of the shortcomings of the prior art, it is a primary object of the present invention to determine longitudinal stiffness of a tire accurately and on an absolute scale. Likewise, it is an object of the invention to determine an effective radius of the wheel accurately and on an absolute scale. These determinations are to be made simultaneously and can use the global positioning system.

It is another object of the invention to provide a method for directly determining longitudinal stiffness of one or more tires and the effective radii of the corresponding wheels in a manner that limits the amount of noise in the estimation algorithm.

It is yet another object of the invention to provide for methods of estimating tire operation parameters including tire pressure, temperature and wear.

Still another object of the invention is to provide a vehicle with appropriate apparatus to take advantage of the methods of invention and enjoy accurate and real-time estimation of operation parameters including tire pressure, temperature and wear.

These and numerous other objects and advantages of the present invention will become apparent upon reading the following description.

### SUMMARY

In one embodiment, the present invention includes a method for monitoring a tire on a monitored wheel of a vehicle such as a car or truck. In one embodiment of the method, a GPS velocity V_{GPS} of the vehicle is measured with a global positioning system and an angular velocity ω of a free-rolling wheel of the vehicle is measured with a wheel sensing unit. For the purposes of this application a free-rolling wheel is understood to be a wheel to which no torque is applied by the vehicle's engine and whose tire is not experiencing any slip. The wheel sensing unit can be, for example, an anti-lock brake system wheel speed sensor.

A free-rolling radius R_{free} of the free-rolling wheel is determined from GPS velocity VGPS and angular velocity ω. In addition, the method calls for deriving an acceleration a of the vehicle. The tire is then monitored based on acceleration a and effective radius R_{eff.} of the monitored wheel. Typically, the tire being monitored is on a driven wheel. In that case, a longitudinal stiffness Cₓ of the tire being monitored is determined simultaneously with the effective radius R_{eff.} when the tire being monitored slips. When the tire being monitored is on a driven wheel, i.e., connected to a powertrain, powertrain force equals mass times acceleration a is used to estimate the force when the vehicle is accelerating. When the tire being monitored is braking, the force equals p times mass times acceleration a is used to estimate the force, where p is brake proportioning constant (0<p<1). Of course, the tire could also be the one on the free-rolling wheel, in which case the longitudinal stiffness Cₓ and the effective radius R_{eff.} may be determined separately, and the monitoring could be performed at various times.

In one embodiment, the method includes translating from GPS velocity VGPS to an absolute velocity V_{abs.}. The translation takes into account well-known factors. (The method also takes into account other well-known factors such as the affect of road grade φ). Preferably, the translation includes determining an angular acceleration α of the free-rolling wheel. Then the free-rolling radius R_{free} is determined from the GPS velocity V_{GPS} when the angular acceleration α is negligible and absolute velocity V_{abs.} is calculated by multiplying the free-rolling radius R_{free} by the angular velocity ω during regular driving when angular acceleration α is non-negligible. The absolute velocity V_{abs.} calculated in this manner is used as the center velocity V_{ctr.} of the monitored wheel. Furthermore, acceleration a of the vehicle is preferably obtained by differencing the absolute velocity V_{abs}.

The method combines the absolute velocity V_{abs.}, angular velocity ω and acceleration a to determine wheel effective radius R_{eff.} and longitudinal stiffness Cₓ. In a preferred embodiment of the method the step of determining longitudinal stiffness Cₓ is performed with the aid of a nonlinear estimation algorithm. For example, the nonlinear estimation algorithm can be a nonlinear force algorithm. Alternatively, the nonlinear estimation algorithm can be a nonlinear energy balance algorithm.

The method of invention further extends to determining at least one tire operation parameter from tire operation parameter from longitudinal stiffness Cₓ and effective radius R_{eff.}. The tire operation parameter can be a tire pressure, a tire temperature or a tire wear. In some embodiments it is convenient to also provide for measuring the tire parameter with an independent measuring device and/or modeling of the tire operation parameter with the aid of a suitable model.

The method of invention can be applied to driven wheels and/or free-rolling wheels. The method can also be used to average the values of longitudinal stiffness Cₓ and effective radius R_{eff.} in wheels attached to the same axle.

In another embodiment the method can be applied without the use of the global positioning unit and take advantage of the nonlinear estimation algorithm alone. Furthermore, the invention also extends to vehicles equipped with a global positioning unit, processing units and a nonlinear estimation module.

A detailed description of the invention and the preferred and alternative embodiments is presented below in reference to the attached drawing figures.

### BRIEF DESCRIPTION OF THE FIGURES

FIG. 1 is a three dimensional diagram illustrating a vehicle with an apparatus for taking advantage of the method according to the invention.

FIG. 2 is a plan diagram illustrating the vehicle of FIG. 1 in more detail.

FIG. 3A is a diagrammatical side view of a free rolling wheel belonging to the vehicle of FIG. 1.

FIG. 3B is a diagrammatical side view of a driven wheel belonging to the vehicle of FIG. 1.

FIG. 4 are graphs illustrating longitudinal stiffness Cₓ and effective radius R_{eff.} of wheels equipped with performance tires and winter tires.

FIG. 5 are graphs illustrating the convergence behavior of longitudinal stiffness Cₓ and effective radius R_{eff.} of wheels equipped with performance tires and winter tires.

### DETAILED DESCRIPTION OF THE EMBODIMENTS

To gain full appreciation of the method of invention it is instructive to first review the various forces acting on a vehicle 10 driving on a surface 12. It should be noted that although vehicle 10 is shown in the form of a passenger car and surface 12 is shown as a road, the method of invention can be applied to any type of terrestrial vehicle moving on any type of surface. In the case shown, road 12 has a road grade described by an inclination angle φ.

Vehicle 10 has front wheels 14A, 14B and rear wheels 16A, 16B, of which right side wheels 14B, 16B are not visible in this view. Front wheels 14A, 14B and rear wheels 16A, 16B are equipped with corresponding air tires 18A, 18B and 20A, 20B. Tires 18A, 18B, 20A and 20B are inflated to pressures P_{lf}, P_{rf}, Pᵢᵣ and Pᵣᵣ, respectively.

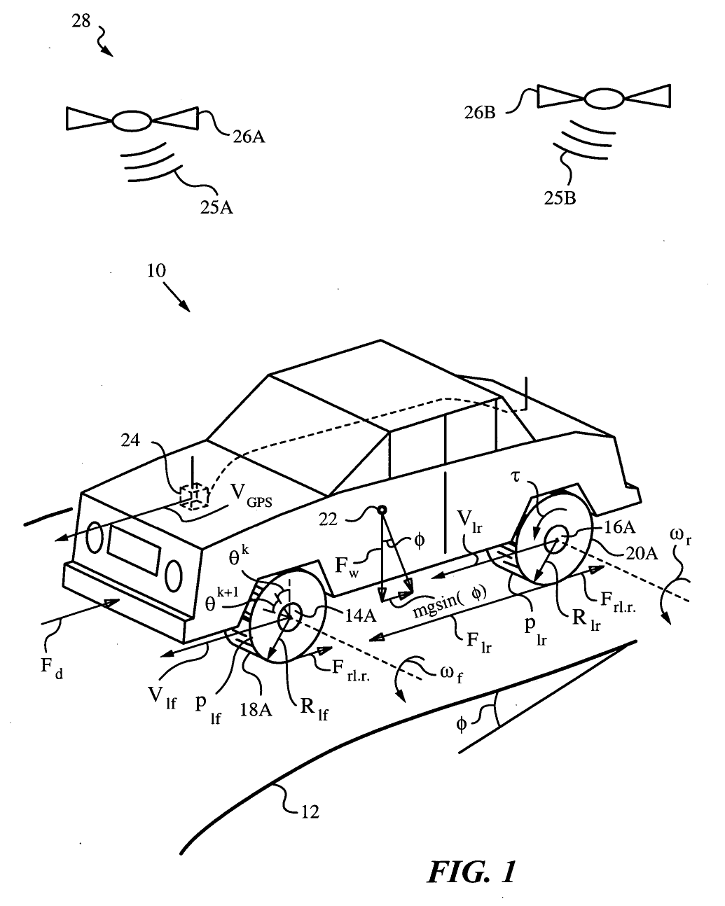

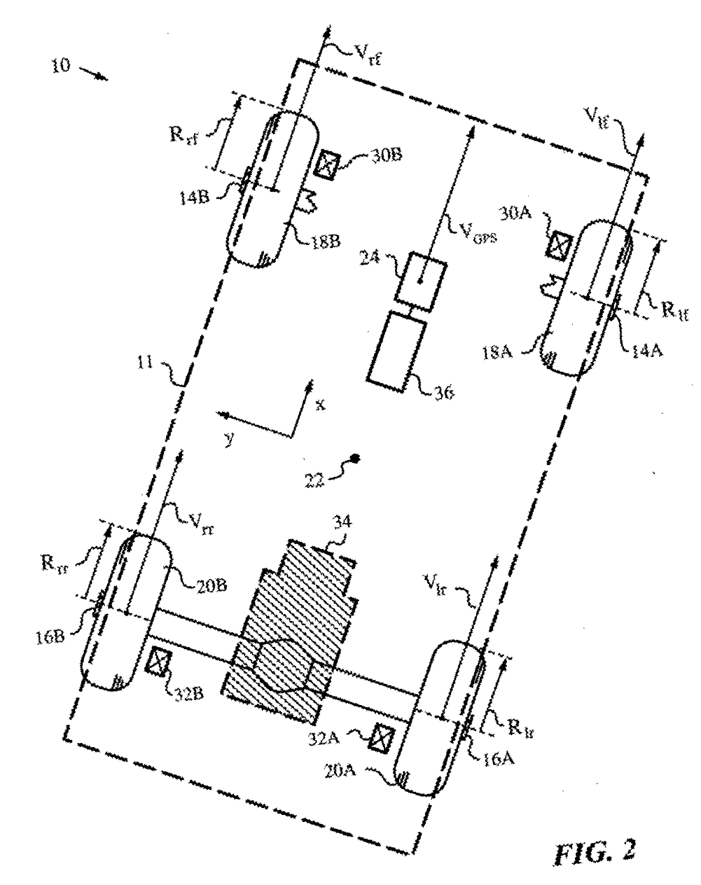

In the present embodiment vehicle 10 is a rear wheel drive, meaning that the torque τ generated by an engine 34 (see FIG. 2) is applied to rear wheels 16A, 16B while front wheels 14A, 14B are permitted to roll freely. Thus, the forces acting on rear wheels 16A, 16B include longitudinal forces Fₗᵣ, Fᵣᵣ generated by the power train of vehicle 10 as well as the force associated with a rolling resistance F_{rl.r.}. In most cases the longitudinal forces applied from engine 34 to rear wheels 16A, 16B are equal Fₗᵣ=Fᵣᵣ and their sum corresponds to a total force Fₓᵣ applied to wheels 16A, 16B mounted on the rear axle. Rolling resistance F_{rl.r.} acts in the opposite direction from longitudinal forces F₁ᵣ, Fᵣᵣ as indicated by corresponding force vectors in FIG. 1. In the rear wheel drive embodiment front wheels 14A, 14B are free-rolling wheels and thus experience rolling resistance F_{r1.r.} only.

In addition to forces acting directly on wheels 14A, 14B, 16A and 16B, vehicle 10 experiences the force caused by aerodynamic drag Fd, which also opposes longitudinal force Fₓᵣ. Furthermore, road grade φ causes a portion of the force of weight Fw acting on a center of mass 22 of vehicle 10 to contribute to the forces acting on vehicle 10. This portion of the force of weight is described by F_{w}sin(φ)=mgsin(φ), where m is the mass of vehicle 10 and g is the gravitational constant.

During normal driving all dominant forces act on tires 18A, 18B, 20A and 20B of free-rolling wheels 14A, 14B and driven wheels 16A, 16B respectively. The net effect or resultant of these dominant forces on tires 20A, 20B of driven wheels 16A and 16B is conveniently expressed by:

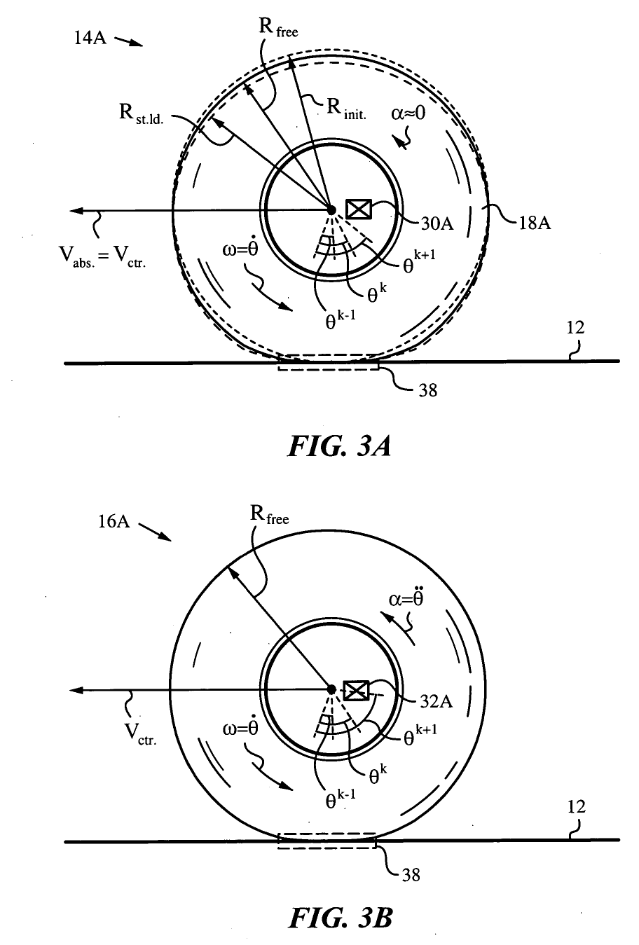

F=ma=Fₓ−Fᵣᵣ−F_{d}−F_{d}−mgsinφ, Eq. 1

where Fₓ is Fₓᵣ since rear wheels 16A, 16B are driven in the present embodiment and Fₒₜₕₑᵣ is the force from other wheels. Fₓ equals the torque τdivided either the static (for a stationary wheel) load radius R_{st.1d.} or free (for a moving wheel) load radius R_{free} of the tire 20A or 20B (see FIGS. 3a and 3b). The torque τmay be determined in an electronic transmission or can be determined directly for the vehicle 10 with a motor 34 (see FIG. 2) that is electric. The mass m of vehicle 10, aerodynamic drag F_{d}, the force from other wheels Fₒₜₕₑᵣ, as well as road grade φ can be determined in any suitable manner. For example, all of these can be estimated with the aid of a GPS system 28. For information on determining these parameters with the aid of GPS system 28 the reader is referred to “Road Grade and Vehicle Parameter Estimation for Longitudinal Control Using GPS”, IEEE Conference on Intelligent Transportation Systems, pp. 166-171, 2001. It should be noted that in the present description these terms have been compensated and they do not appear in subsequent equations and discussion for the sake of clarity. Additional effects, such as the front-to-rear weight distribution of vehicle 10 can be determined from the lateral dynamics of vehicle 10. See David M. Bevly et al., “Integrated INS Sensor with GPS Velocity Measurements for Continuous Estimation of Vehicle Sideslip and Tire Cornering Stiffness,” Proceedings of American Control Conference 2001, vol. 1, pp. 25-30.

The dominant forces as well as road friction and operating conditions of tires 18A, 18B, 20A and 20B cause one or more of wheels 14A, 14B, 16A, 16B to slip. A well-known definition for wheel slip S is:

$$S = - ( \frac{{V}_{ctr .} - {R}_{eff .} ω}{{V}_{ctr .}} ) , \qquad Eq . 2$$

where V_{ctr.} is the velocity of the center of the slipping wheel, R_{eff.} is its effective radius exhibited at times when no external torque is applied around the spin axis and ω is its angular velocity. In the linear region in which most ordinary driving occurs and to which the method of invention is preferably applied wheel slip S rarely exceeds 2%. In this linear region the relationship between the force F transmitted by tires 20A, 20B on driven wheels 16A, 16B to road 12 and their slip S is described by the following relationship:

$$F = {C}_{x} S = {C}_{x} ( \frac{{V}_{ctr .} - {R}_{eff .} ω}{{V}_{ctr .}} ) , \qquad Eq . 3$$

where Cₓ is the longitudinal stiffness of rear tires 20A, 20B transmitting the force. The slip of free-rolling wheels 14A, 14B is calculated with the same equation. In this case, however, the force must be generated in another way, typically via braking. To estimate the force during braking, the left-hand-side of equation 2 is modified to include brake proportioning constant p (0<p<1) times ma.

It should be noted that in most cases only tires on driven wheels are monitored. Hence, it is the slip of driven wheels 16A, 16B and longitudinal stiffness Cₓ of driven tires 20A, 20B that is determined. Nonetheless, the method of invention can also be applied to obtain the slip S of free-rolling wheels 14A, 14B and longitudinal stiffness Cₓ of free-rolling tires 18A, 18B. It should also be noted that all wheels 14A, 14B, 16A, 16B can be considered free-rolling for the purposes of the method of the present invention when no torque τ is applied to them and when vehicle 10 is experiencing negligible acceleration (a≈0). Hence, the method of invention can be applied to vehicles with any configuration of driven and undriven wheels, including all-wheel drive vehicles. In the case of all-wheel drive vehicles, the left-hand-side of equation 2 is modified to include powertrain proportioning constant pₚ times ma. Values of pₚ depend on the manufacturer. Representative values are pₚ=0.2 and pₚ=0.8, for front wheels and back wheels, respectively.

In accordance with the invention, vehicle 10 is equipped with a global positioning (GPS) receiver or unit 24. GPS unit 24 receives signals 25A, 25B from satellites 26A, 26B of GPS system 28. Although two satellites 26A, 26B are shown in FIG. 1, it is known in the art that more satellites can be in communication with GPS unit 24 at any point in time. Unit 24 is designed to obtain a GPS velocity V_{GPS} from signals 25A, 25B and translate V_{GPS} to an absolute velocity V_{abs.} of vehicle 10. In performing this translation unit 24 takes into account other factors as well as measurements from additional resources as necessary (not shown). For further information on translating GPS velocity V_{GPS} to absolute velocity V_{abs.} based on GPS signals the reader is referred to David Bevly et al., “The Use of GPS Based Velocity Measurements for Improved Vehicle State Estimation”, Proceedings of the American Control Conference, Chicago, Ill., pp. 2538-2542, 2000 and Shannon L. Miller et al., “Calculating Longitudinal Wheel Slip and Tire Parameters Using GPS Velocity”, Proceedings of the American Control Conference, 2001.

The diagram in FIG. 2 shows a plan outline 11 of vehicle 10 and the engine 34 applying torque τ to rear wheels 16A, 16B. Vehicle 10 is equipped with wheel sensing units 30A, 30B at front wheels 14A, 14B and wheel sensing units 32A, 32B at rear wheels 16A, 16B. Wheel sensing units 30A, 30B, 32A and 32B measure the angular velocity ω of corresponding wheels 14A, 14B, 16A, 16B. Wheel sensing units 30A, 30B, 32A and 32B can be of any type including accelerometers, though in the preferred embodiment they belong to an anti-lock braking system (ABS). More specifically, they are the ABS variable reluctance sensors that obtain angular velocity ω from the time rate of change of an angle θ through which the wheel has rotated. This time rate of change of angle θ is designated by \dot{θ} where the dot represents the time derivative

$$\frac{ⅆ}{ⅆ t} .$$

The measurements of the value of angle θ are taken at discrete time steps k as indicated in the superscript (see FIG. 1).

Vehicle 10 has a central processing unit 36 to which GPS unit 24 is connected. Unit 36 is also in communication with sensing units 30A, 30B, 32A and 32B with the aid of appropriate communication links (not shown). Unit 36 is also connected to a display (not shown) for displaying operational parameters of tires 18A, 18B, 20A and 20B. In another embodiment, operational parameters of tires 18A, 18B, 20A and 20B are used in a feedback control system to modify operation of vehicle 10 or in network monitoring of tires 18A, 18B, 20A and 20B.

In the preferred embodiment, GPS velocity V_{GPS} is translated to an absolute velocity V_{abs.} of vehicle 10 as follows.

First, one determines an angular acceleration α of a free-rolling wheel (14A or 14B). In the present case wheel 14A is selected for this purpose. Referring now to FIG. 3A, angular acceleration α of wheel 14A is obtained with an accelerometer (not shown) or by double differencing the values of angle θ measured by unit 30A at equal, successive time intervals. Angular acceleration a can also be obtained by single differencing GPS velocity V_{GPS} or, in embodiments in which unit 30A is capable of sensing angular velocity ω directly, by single differencing ω. A person skilled in the art will appreciate that there are numerous methods and sensors that can be used to obtain angular acceleration α of free rolling wheel 14A. In the present embodiment sensing unit 30A measures angle θ rather than angular velocity ω, and angular acceleration α is obtained by double differencing θ. In the present case three values of angle θ measured at three successive time steps are indicated with the aid of superscripts k−1, k, k+1.

Second, one determines the free-rolling radius R_{free} of free-rolling wheel 14A. At rest, tire 18A of wheel 14A is deformed from an undeformed initial radius R_{init.} to the static loaded radius R_{st.1d.}. This occurs mainly because tire 18A flattens along a contact patch 38 where it is in contact with road 12. When wheel 14A rolls tire 18A undergoes further deformation to assume free-rolling radius R_{free} that is somewhere between initial radius R_{init.} and static loaded radius R_{st.1d.}. For the purposes of the invention it is important that free-rolling radius Rfree of wheel 18A be determined to sub-millimeter accuracy from GPS velocity V_{GPS} at a time when angular acceleration α of wheel 18A is negligible (α≈0) which corresponds to a situation when the successive values of θ, namely θ^{k-1}, θ^{k}, θ^{k+1}, are approximately equal, as indicated in FIG. 3A. This is accomplished by dividing GPS velocity V_{GPS} by angular velocity ω when vehicle 10 is in uniform linear motion, i.e., at times where vehicle 10 is moving along a straight line and is not experiencing any appreciable positive or negative acceleration. This condition can be expressed as follows:

$${R}_{free} = \frac{{V}_{GPS}}{ω} {\vert}_{α = 0} .$$

Third, absolute velocity V_{abs.} of vehicle 10 is determined during regular driving. At those times angular acceleration α is usually non-negligible because vehicle 10 experiences positive and negative acceleration including changes in speed and direction of motion. Absolute velocity V_{abs.} of vehicle 10 is determined at those times by multiplying free-rolling radius R_{free} by angular velocity ω. It should be noted that free-rolling radius Rfree of free-rolling wheel 14A is computed when no external torque is applied about the spin axis of wheel 14A. Hence, in accordance with the above definition, free-rolling radius R_{free} is also the effective radius R_{eff.} of free-rolling wheel 14A.

In the method of invention absolute velocity V_{abs.} is used as the velocity of the center V_{ctr.} of free-rolling wheels 14A, 14B as well as driven wheels 16A, 16B. Any one or any combination of these wheels can be monitored. For simplicity, in the present discussion only driven wheel 16A is chosen as monitored wheel.

Referring now to FIG. 3B, wheel 16A is illustrated during regular driving when vehicle 10 experiences acceleration and the values of angle θ, namely values θ^{k-1}, θ^{k}, θ^{k+1}, through which wheel 16A rotates during equal, successive time steps change. Angular acceleration α at these times is not negligible and is obtained by double differencing angle θ measured by sensing unit 32A.

Absolute velocity V_{abs.} derived from free-rolling wheel 14A in the manner described above is now used as the center velocity V_{ctr.} of monitored wheel 16A. Also, acceleration a of vehicle 10 is derived by differencing absolute velocity V_{abs.}. Equipped with these values of center velocity V_{ctr.} and acceleration a central processing unit 36 now uses a reformulation of equation 3 to simultaneously compute the values of the effective radius R_{eff.} of monitored wheel 16A and the longitudinal stiffness Cₓ of monitored wheel 16A. (For a driven and thus slipping wheel, the longitudinal stiffness Cₓ and the effective radius Reff are related via equation 3. Therefore, these quantities are determined simultaneously for a driven wheel.)

It should be noted that in the prior art this is typically done with the aid of a linear estimation algorithm developed from equation 3 and often expressed as:

$$\hat{a} = [ \begin{matrix}- \frac{1}{m} & \frac{{\hat{ω}}_{d}}{m \hat{V}}\end{matrix} ] ⌊ \begin{matrix}{C}_{x} \\ {R}_{d} {C}_{x}\end{matrix} ⌋ , \qquad Eq . 4$$

in which m is the mass of vehicle 10, â, \hat{ω}_{d}, \hat{V} are acceleration of vehicle 10, angular velocity of driven wheel 16A (monitored wheel) and velocity of vehicle 10. The hat notation represents measured values or values calculated from measurements. Unfortunately, linear estimation algorithms of this type fail to provide reasonable estimates of tire operating parameters, as already remarked in the background section.

In contrast to prior art linear estimation algorithms the method of invention employs a nonlinear estimation algorithm. More precisely, the method of invention is based on a nonlinear formulation that is most conveniently expressed in a nonlinear force algorithm or a nonlinear energy balance algorithm. The approach minimizes measurement errors [Δθ_{d};Δθᵤ] in the wheel angle measurements θ_{d}, θᵤ of driven wheels 16A, 16B and undriven wheels 14A, 14B. The philosophy of this approach is called, orthogonal regression, errors in the variables (EIV) or more recently a Total Least Squares (TLS) problem. For more information on the mathematical theory of TLS, the reader is referred to S. Van Huffel and Joos Vandewalle, “The Total Least Squares Problem: Computational Aspects and Analysis”, Society for Industrial and Applied Mathematics, Philadelphia, 1991.

The nonlinear force algorithm and nonlinear energy balance algorithm differ in formulation, since the first is based on force equation 3 while the second is based on an energy equation. We will first illustrate how the nonlinear formulation is applied to obtain the nonlinear force algorithm. To this effect, measurement noise perturbations are explicitly introduced into equation 3 and all terms are moved to the right hand side as follows:

$$m {R}_{u}^{2} ⌊ \frac{{ⅆ}^{2}}{ⅆ {t}^{2}} ( {θ}_{u} + Δ {θ}_{u} ) ⌋ [ \frac{ⅆ}{ⅆ t} ( {θ}_{u} + Δ {θ}_{u} ) ] + \\ {C}_{x} ( {R}_{u} [ \frac{ⅆ}{ⅆ t} ( {θ}_{u} + Δ {θ}_{u} ) ] - {R}_{d} [ \frac{ⅆ}{ⅆ t} ( {θ}_{u} + Δ {θ}_{u} ) ] ) = 0 \qquad Eq . 5$$

The solution to this equation is iterative and the time derivatives are approximated by first order finite difference equations. Retaining the hat convention for denoting a measured value or value derived from measurement let each measurement be written as:

\hat{θ}^{k}=θ^{k}+Δθ^{k}

then, differencing to obtain the first two time derivatives yields:

$$\begin{matrix}{\dot{\hat{θ}}}^{k} ≅ \frac{{\hat{θ}}^{k + 1} - {\hat{θ}}^{k - 1}}{2 T} , & Eq . 6 \\ {\ddot{\hat{θ}}}^{k} ≅ \frac{{\hat{θ}}^{k + 2} - 2 {\hat{θ}}^{k} + {\hat{θ}}^{k - 2}}{4 {T}^{2}} , & Eq . 7\end{matrix}$$

where subscript k indicates the discrete time step between successive measurements and T represents the digital sampling time.

The goal of minimizing the sum of the squared measurement errors to yield the correct parameter estimates in the presence of Independent Identically Distributed (IID) noise can then be expressed as a minimization of a cost function as follows:

$$\begin{matrix}\begin{matrix}Minimize \\ {R}_{eff .} , {C}_{x}\end{matrix} \text{:} & ‖ \begin{matrix}Δ {θ}_{u} \\ Δ {θ}_{d}\end{matrix} ‖\end{matrix} \\ \begin{matrix}subject to \text{:} & {f}^{k} ( {\hat{θ}}_{u} , {\hat{θ}}_{d} , Δ {θ}_{u} , Δ {θ}_{d} , {R}_{d} , {C}_{x} ) = 0\end{matrix} \qquad Eq . 8$$

As a modification to the approach presented above, the basic parameter identification problem can be cast as an energy balance instead of a force balance. In this approach, the basic equation of motion is integrated over time to produce the following relationship:

$$\begin{matrix}m \frac{ⅆ {V}_{ctr}}{ⅆ t} = - {C}_{x} ( \frac{{V}_{ctr} - {R}_{eff} ω}{{V}_{ctr}} ) \\ m \int {V}_{ctr} ⅆ {V}_{ctr} = - {C}_{x} \int ( {V}_{ctr} - {R}_{eff} ω ) ⅆ t \\ m {V}_{ctr}^{2} - m {V}_{ctr0}^{2} = - 2 {C}_{x} ( X - {R}_{eff} θ )\end{matrix}$$

This last equation relates the change in the kinetic energy of the vehicle 10 to the product of the longitudinal stiffness Cₓ and the slipped distance of the tire 18A, 18B, 20A or 20B (the difference between the distance the vehicle 10 has traveled along the road, X, and the distance that the rotating wheel 14A, 14B, 16A or 16B has traveled).

A specific example of this general formulation can be generated for the case where the velocity Vctr of the vehicle 10 is measured from the un-driven wheels 14A and 14B of a two-wheel drive vehicle 10. In this case, the energy balance gives:

mRᵤ²(θ^{&}ᵤ−θ^{&}^{u0})=−2Cₓ(Rᵤθᵤ−R_{d}θ_{d})

Adding in the perturbation terms for measurement noise gives:

$${{mR}_{u}^{2} [ \frac{ⅆ}{ⅆ t} ( {θ}_{u} + Δ {θ}_{u} ) ]}^{2} - {{mR}_{u}^{2} [ \frac{ⅆ}{ⅆ t} ( {θ}_{u0} + Δ {θ}_{u0} ) ]}^{2} + 2 {C}_{x} ( {R}_{u} ( {θ}_{u} + Δ {θ}_{u} ) - {R}_{d} ( {θ}_{d} + Δ {θ}_{d} ) ) = 0$$

The above equation can be used as a constraint equation while minimizing the sum of the squared measurement errors as before. This approach can be further modified to include the effect of elevation changes, such as the road grade φ, in the energy balance in order to account for changes in potential energy.

The nonlinear optimization problem in equation 8 may be solved as follows. For any value of Cₓ and R_{eff.} one explicitly solves for the Δθᵤ and Δθ_{d} which satisfy the constraint equation via a nonlinear minimum norm algorithm. For example one may use a Gauss-Newton algorithm which linearizes the constraint equation and solves for the linear least norm solution at each update step until the parameters converge. Then simply select an upper and lower bound on the parameters Cₓ and R_{eff.} and search the parameter space by bisection until the minimum of the minimum norm solutions has been found.

Fortunately, the cost function for this optimization problem is locally quasiconvex for physically meaningful parameter values as demonstrated, e.g., by Christopher R. Carlson and J. Christian Gerdes, “Identifying Tire Pressure Variation by Nonlinear Estimation of Longitudinal Stiffness and Effective Radius”, Proceedings of AVEC 2002 6th International Symposium of Advanced Vehicle Control, 2002. As such, once the true values are bracketed, a bisection algorithm is guaranteed to converge to the optimal solution.

In the preferred embodiment of the method of invention the problem of finding the optimal solution is preferably recast to take advantage of two improvements. First, the problem is stated as nonlinear least squares problem rather than the standard bisection algorithm. The second improvement uses the sparse structure of the cost function gradient to speed up the required linear algebraic operations.

Bisection algorithms are guaranteed to converge for quasiconvex functions but may take many iterations to do so. The first improvement solves this optimization problem as a nonlinear total least squares (NLTLS) problem with backstepping. In the present method of invention the NLTLS problem is set up by letting f be the true nonlinear model:

f(θᵤ, x)=θ_{d} Eq. 9

where θᵤ and θ_{d} are vectors of true model values and x=[Cₓ,R_{d}]^{T} is the vector of model parameters. The vectors of measurements are disturbed by noise as follows:

$$\begin{matrix}Minimize \text{:} ‖ \begin{matrix}Δ {θ}_{u} \\ Δ {θ}_{d}\end{matrix} ‖ \\ x , Δ {θ}_{u} , Δ {θ}_{d}\end{matrix} \qquad Eq . 10$$

subject to: f(\hat{θ}ᵤ−Δθᵤ,x)=\hat{θ}_{d}−Δθ_{d} Eq. 11

This problem is conveniently solved by writing an equivalent nonlinear least squares problem of higher dimension. The theory behind such equivalent formulation can be found in H. Schwetlick and C. Tiller, “Numerical Methods for Estimating Parameters in Nonlinear Models with Errors in Variables”, Technometrics, 27(1), pp. 17-24, 1985. In the present case the equivalent nonlinear least squares problem is conveniently written as:

$$\begin{matrix}Minimize \\ {θ}_{u} , x\end{matrix} ‖ \begin{matrix}f ( {θ}_{u} , x ) - {\hat{θ}}_{d} \\ {θ}_{u} - {\hat{θ}}_{u}\end{matrix} ‖ \qquad Eq . 12$$

Solutions to this problem iteratively approximate the nonlinear function as quadratic and solve a local linear least squares problem. This can be seen by letting:

$$\begin{matrix}Θ = ⌊ \begin{matrix}x \\ {θ}_{u}\end{matrix} ⌋ & Eq . 13 \\ g ( Θ ) = ⌊ \begin{matrix}f ( {θ}_{u} , x ) - {\hat{θ}}_{d} \\ {θ}_{u} - {\hat{θ}}_{u}\end{matrix} ⌋ & Eq . 14\end{matrix}$$

and iteratively solving the problem as follows:

$${J}^{i} = \frac{\partial g ( Θ )}{\partial Θ} {\vert}_{{Θ}^{i}} \qquad Eq . 15$$

Θⁱ⁺1=Θⁱ+αJ^{†}gⁱ(Θⁱ) Eq. 16

until the Θⁱ converges, where i refers to the iteration number, † represents the least squares pseudoinverse and 0<α<1 is the backstepping parameter. The initial conditions can be set according to the most likely values. For example, the linear least squares parameter estimates and zeroes for the measurement errors can be set as the initial conditions. Typically, the solution converges in less than ten iterations and uses a backstepping parameter of α=0.8.

The second improvement in the method of invention is realized by using the QR factorization (QRF) technique as the tool for determining the pseudoinverse of least squares pseudoinverse matrix in equation 16. Algorithms for finding the QRF quickly by exploiting scarcity patterns in matrices are further described by Ake Bjorck, Matrix Computations, 3^{rd} edition, Society for Industrial and Applied Mathematics, Philadelphia, 1996 and by Gean H. Golub and Charles F. Van Loan, Matrix Computations, 3^{rd} edition, The Johns Hopkins University Press, Baltimore and London, 1996. Algorithmic improvements are easily realized once the structure of the gradient matrices in equation 15 are made clear.

The gradient of equation 9 with respect to the regressors Θ=[θᵤ^{T},x^{T}]^{T} has the structure:

$$\begin{matrix}J = ⌊ \begin{matrix}\frac{\partial f ( {θ}_{u} , x )}{\partial {θ}_{u}} & \frac{\partial f ( {θ}_{u} , x )}{\partial x} \\ \frac{\partial f ( {θ}_{u} - {\hat{θ}}_{u} )}{\partial {θ}_{u}} & \frac{\partial f ( {θ}_{u} - {\hat{θ}}_{u} )}{\partial x}\end{matrix} ⌋ & Eq . 17 \\ = ⌊ \begin{matrix}{B}_{n \times n} & {D}_{n \times 2} \\ {I}_{n \times n} & {0}_{n \times 2}\end{matrix} ⌋ & Eq . 18\end{matrix}$$

where n is the number of data points and B_{n×n} represents a banded nxn matrix and D_{n×2} is a dense n×2 matrix. For the nonlinear force algorithm based on equation 5 the matrix has 5 bands. Techniques outlined by Ake Bjorck, op cit. for solving Tikhonov regularized problems, via Givens rotations for example, can be adapted to find the least squares inverse for matrices with this structure.

Referring back to FIG. 2, in vehicle 10 central processing unit 36 implements either the nonlinear force algorithm as outlined above or the nonlinear energy balance algorithm to determine longitudinal stiffness Cₓ and effective radius R_{eff.} of driven wheel 16A. The same algorithm is used to determine the longitudinal stiffness Cₓ and effective radius R_{eff.} of driven wheel 16B. The nonlinear force and energy balance algorithms consistently estimate longitudinal stiffness Cₓ within about 2% to 3% for data sets on the order of 600 points long, which is markedly superior to prior art performance.

In a preferred embodiment, central processing unit 36 comprises an estimation module for performing the above computations based on most likely initial conditions. Most preferably, the estimation module is a nonlinear estimation module for implementing the nonlinear algorithms.

The teaching presented above may be readily applied to other similar sensor configurations. For example on four wheel drive vehicles there is not a free-rolling wheel which may be used for computing the absolute velocity V_{abs.} to be used as reference (as described previously, for four wheel drive vehicles the left-hand-side of equation 2 is modified to include the powertrain proportioning constant pp times ma). The teachings presented here may be applied to this case by using GPS velocity V_{GPS} directly in the estimation algorithms and rewriting the cost functions as follows:

$$\begin{matrix}\begin{matrix}Minimize \\ {R}_{eff} , {C}_{x}\end{matrix} \text{:} ‖ \begin{matrix}ΔV \cdot ω \\ Δ {θ}_{d}\end{matrix} ‖ \\ subject to \text{:} {f}^{k} ( V , {θ}_{d} , Δ V , Δ {θ}_{d} , {R}_{d} , {C}_{x} ) = 0\end{matrix} \qquad Eq . 19$$

where V is GPS velocity V_{GPS} and w is a weighting term which makes the variance of the wheel speed measurements and the variance of weighted GPS velocity noises the same. In this way, the tire properties of each individual tire on the vehicle can be estimated individually.

In another embodiment of the method, a measurement of braking forces is used in the force and energy balance equations. In this case, the errors in cost function are rewritten in a way that minimizes the measurement errors and not the equation errors for the estimation problem. As described previously, in determining the effective radius R_{eff} and the longitudinal stiffness Cₓ the force must be generated in another way, typically via braking. To estimate the force during braking, the left-hand-side of equation 2 is modified to include the brake proportioning constant p (0<p<1) times ma. A similar modification is made to the energy balance equations.

### EXAMPLE

The method of invention was tested on a rear wheel drive 1999 Mercedes E320 with stock installed variable reluctance Antilock Braking System (ABS) sensors. These sensors served the function of wheel sensing units determining angle θ as described above. A Novatel GPS receiver was used by the GPS system. The central processing unit was a Versalogic single board computer running the MATLAB XPC embedded realtime operating system with nonlinear estimation modules executing the algorithm of the invention. This system records and processes 20 data streams at sample rates up to 1000 Hz.

In order to hold as many tire variables constant as possible, the data for these results were collected on the same section of asphalt on a flat, straight, dry runway parallel to eliminate the effects of turning and road grade φ from the measurements.

Force was applied to the tires by accelerating with throttle and decelerating with engine braking only. Thus the undriven wheels were free to roll at all times. The test road has no overhanging trees or tall buildings nearby so the GPS antenna had an unobstructed view of the sky and was unlikely to experience multipath errors. Wheel angular displacements ok were recorded at 200 Hz, summed over the length of the data set and then sub-sampled at 10 Hz to reduce the auto correlation of high frequency wheel modes and reduce the computational cost of the nonlinear solution. The data sets were on the order of 600-900 points long.

The tire operation parameters studied included tire pressure, tire temperature and tire wear as evidenced by thread depth. Vehicle loading and surface lubrication were also taken into account for longitudinal slip estimation. Tests were performed on the following tires:

1) ContiWinterContact TS790,215/55 R16

2) Goodyear Eagle F1 GS-D2, 235/45 ZR17

under conditions outlined in Table 1 below. Testing a tread depth of 2.5 mm shows the performance of a tire toward the end of its operational life.

TABLE 1
Test Matrix for Performance and Winter Tires
Tire Test Matrix

| # | Pressure | Tread | Weight |
|---|---|---|---|
| 1 | nominal | full | driver only |
| 2 | −10% | full | driver only |
| 3 | −20% | full | driver only |
| 4 | nominal | 2.5 mm | driver only |
| 5 | nominal | full | driver + 200 kg |
| 6 | nominal | full | driver + 400 kg |
| 7 | nominal | full, wet | driver only |

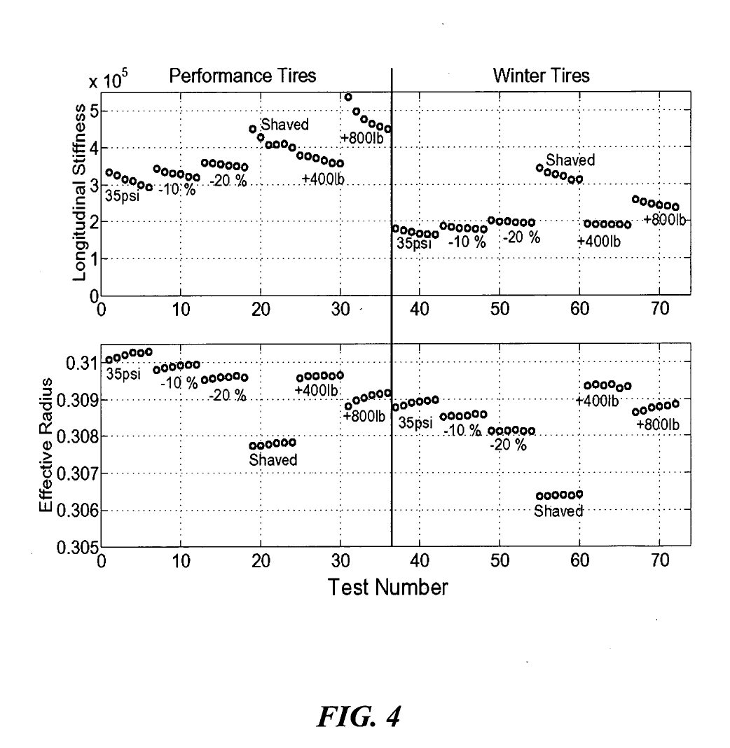

FIG. 4 shows the results of several tests. Each circle represents one 45-60 second data set during the bracketed test conditions. As such, each cluster represents a series of six data sets taken consecutively. It should be noted that all data clusters tend down and to the right. That is because the process of testing the tires alters their longitudinal stiffness Cₓ property in two ways. The slipping of the tire raises its internal temperature, which expands the air inside the tire; typical internal pressure variation was 1-2 psi pre to post data run. Additionally, the elastomeric properties of the rubber itself change. As the tire heats up, the rubber becomes easier to deform and thus lowers the tire's longitudinal stiffness. (One skilled in the art could compensate for this effect by waiting a few minutes for the tires to heat up. Tire warm up is a well-known aspect of tire behavior and it is reasonable to let the tires run a little bit before diagnosing them. Alternately, a lookup table which has been generated for the tires could include a dimension which takes into account an estimate of the tire warm up process.)

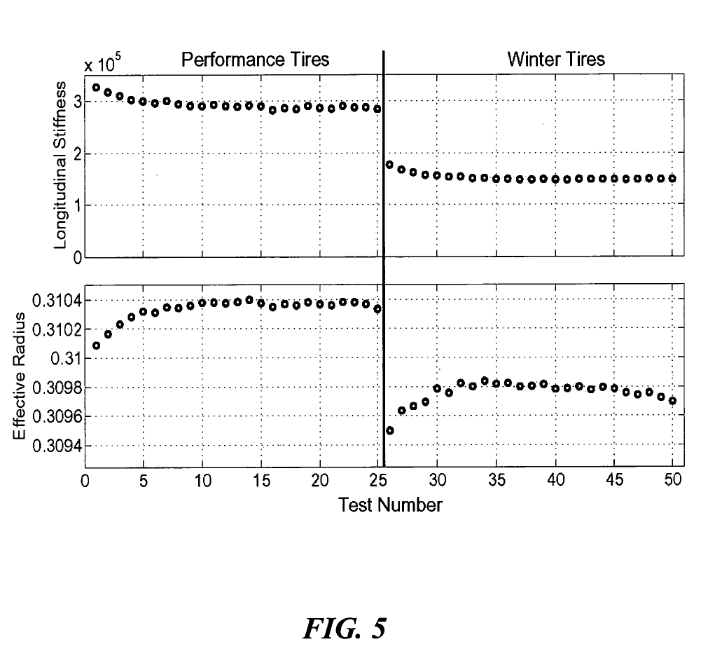

The first clusters in FIG. 5 show a series of 25 data sets taken consecutively to explore the convergence of this behavior for both types of tires. The estimates come to steady state after about 10 data runs when the frictional heating during the run equaled the cooling during the return lap to the starting point of the test. The consistency of the parameter estimates during these experiments is extremely good, within about 2.5% for longitudinal stiffness Cₓ estimates.

The wheel effective radius R_{eff.} estimates are highly consistent, regularly returning values with submillimeter accuracy. It should be noted that the wheel effective radius R_{eff.} varies by less than one millimeter for tire pressure changes of 20%.

The method of invention is the most accurate and precise estimator for longitudinal stiffness and wheel effective radius which has appeared in the literature. This system, combined with an in-tire temperature and pressure measurement device provides a reliable tread-wear indicator. Combined with a tire life model a temperature model, this estimator identifies tire pressure. Given tire pressure and tread wear, this system identifies the operating temperature of the tire. The pressure, temperature, tread-wear indicators can be used for warning/maintenance suggestions to the operator/fleet etc. This estimation structure, combined with GPS and a brake force model estimates individual tire longitudinal stiffnesses and effective radii. This system parameterizes key values for vehicle models, such as for stability control. A look up table is probably the most direct way of determining the tire operation parameters. A vehicle manufacturer, tire manufacturer, or a vehicle fleet which is all communicating, would have to measure and determine what the tire parameters are when the tire is, low on pressure, worn, hot, etc. and then record those values. The central processing unit 36 would then use a model or lookup table to compare current measurements to the conditions in the lookup table. For example, the car reads Cₓ=3e5 and the lookup table says 3e5 corresponds to 35 psi. The resulting operational parameters may be displayed on the display.

With a few modifications (rewriting of the cost functions), the estimation scheme can be modified to parameterize nonlinear tire behavior. This system applied to a fleet of communicating vehicles can identify tires which behave significantly different (hotter, stiffer, etc.) than average. Combined with a sideslip and side-force estimator this system identifies the tire friction circle. This system can be used to detect some fraction of tires that are behaving significantly differently (e.g., are defective) on a many wheeled vehicle. For instance on a 4 wheeled vehicle it can detect one soft or stiff tire. Given a set of different tire properties (winter/summer), this system identifies which tires are installed on the vehicle during normal driving.

In view of the above, it will be clear to one skilled in the art that the above embodiments may be altered in many ways without departing from the scope of the invention. Accordingly, the scope of the invention should be determined by the following claims and their legal equivalents.

What is claimed is:

1. A method for monitoring a tire on a wheel of a vehicle, said method comprising:
a) measuring an absolute vehicle velocity V_{abs.} of said vehicle;
b) measuring an angular velocity ω of said wheel; and
c) determining an effective radius R_{eff.} of said wheel and a longitudinal stiffness Cₓ of said tire from said absolute vehicle velocity V_{abs.}, said angular velocity ω and said acceleration a with an estimation algorithm.

2. The method of claim 1, wherein said effective radius R_{eff.} and said longitudinal stiffness Cₓ of said tire are determined from slip equation during braking for said monitored wheel that is free rolling or from said slip equation when torque is applied for said monitored wheel that is driven.

3. The method of claim 2, wherein determining said longitudinal stiffness Cₓ and said effective radius R_{eff.} comprises a nonlinear estimation algorithm.

4. The method of claim 3, further comprising the step of deriving an acceleration a of said vehicle, wherein said nonlinear estimation algorithm comprises a nonlinear force algorithm.

5. The method of claim 3, wherein said nonlinear estimation algorithm comprises a nonlinear energy balance algorithm.

6. The method of claim 2, wherein said absolute vehicle velocity V_{abs.} of said vehicle is derived from a GPS velocity V_{GPS} obtained from a global positioning unit.

7. The method of claim 2, wherein acceleration a is derived by differencing said absolute vehicle velocity V_{abs.}.

8. The method of claim 2, further comprising determining at least one tire operation parameter from said longitudinal stiffness Cₓ and said effective radius R_{eff.}.

9. The method of claim 8, wherein said at least one tire operation parameter is selected from the group consisting of tire pressure, tire temperature and tire wear.

10. The method of claim 1, further comprising the step of correcting for disturbances selected from the group consisting of road grade φ, aerodynamic drag and rolling resistance.

11. The method of claim 1, wherein torque on said wheel is measured directly.

12. A method for monitoring a tire on a monitored wheel of a vehicle, said method comprising:
a) obtaining a GPS velocity VGPS Of said vehicle;
b) measuring an angular velocity ω of a free-rolling wheel of said vehicle;
c) deriving a free-rolling radius Rfree of said free-rolling wheel from said GPS velocity VGPS and said angular velocity ω;
e) deriving an effective radius R_{eff.} and a longitudinal stiffness Cₓ of said monitored wheel; and
f) monitoring said tire on said monitored wheel based on said effective radius R_{eff.}.

13. The method of claim 12, wherein said effective radius R_{eff.} and said longitudinal stiffness Cₓ of said tire are determined from slip equation during braking for said monitored wheel that is free rolling or from said slip equation when torque is applied for said monitored wheel that is driven.

14. The method of claim 13, wherein determining said longitudinal stiffness Cₓ and said effective radius R_{eff.} comprises a nonlinear estimation algorithm.

15. The method of claim 14, further comprising determining at least one tire operation parameter from said longitudinal stiffness Cₓ and said effective radius R_{eff.}.

16. The method of claim 15, wherein said at least one tire operation parameter is selected from the group consisting of tire pressure, tire temperature and tire wear.

17. The method of claim 16, further comprising the step of deriving an acceleration a of said vehicle, wherein said nonlinear estimation algorithm comprises a nonlinear force algorithm.

18. The method of claim 16, wherein said nonlinear estimation algorithm comprises a nonlinear energy balance algorithm.

19. The method of claim 12, further comprising the step of correcting for disturbances selected from the group consisting of road grade φ, aerodynamic drag and rolling resistance.

20. The method of claim 12, further comprising translating from said GPS velocity V_{GPS} to an absolute velocity V_{abs.}.

21. The method of claim 20, wherein said step of translating comprises:
a) determining an angular acceleration α of said free-rolling wheel;
b) determining said free-rolling radius R_{free} from said GPS velocity V_{GPS} when said angular acceleration α is negligible;
c) calculating said absolute velocity V_{abs.} by multiplying said free-rolling radius R_{free} by said angular velocity ω when said angular acceleration α is non-negligible.

22. The method of claim 21, wherein said absolute velocity V_{abs.} is used as a center velocity V_{ctr.} of said monitored wheel.

23. The method of claim 21, wherein acceleration a is derived by differencing said absolute velocity V_{abs.}.

24. The method of claim 23, further comprising determining said effective radius R_{eff.} and a longitudinal stiffness Cₓ of said tire from acceleration a.

25. The method of claim 24, wherein determining said longitudinal stiffness Cₓ and said effective radius R_{eff.} comprises a nonlinear estimation algorithm.

26. The method of claim 25, wherein said nonlinear estimation algorithm comprises a nonlinear force algorithm.

27. The method of claim 25, wherein said nonlinear estimation algorithm comprises a nonlinear energy balance algorithm.

28. The method of claim 12, wherein said monitored wheel is a driven wheel.

29. The method of claim 12, wherein torque on said monitored wheel is measured directly.

30. A vehicle comprising:
a) at least one wheel having a tire;
b) a global positioning unit for measuring a GPS velocity V_{GPS} of said vehicle;
c) a wheel sensing unit for measuring an angular velocity ω of a free-rolling wheel of said vehicle;
d) a processing unit in communication with said global positioning unit for receiving said GPS velocity V_{GPS} and in communication with said wheel sensing unit for receiving said angular velocity ω, wherein said processing unit determines a free-rolling radius R_{free} of said at least one wheel from said GPS velocity V_{GPS} and said angular velocity ω.

31. The vehicle of claim 30, wherein said wheel sensing unit comprises an anti-lock braking system.

32. The vehicle of claim 30, further comprising an estimation module for determining an acceleration a of said vehicle and obtaining an effective radius R_{eff.} and a longitudinal stiffness Cₓ from said acceleration α.

33. The vehicle of claim 32, wherein said estimation module is a nonlinear estimation module.

34. A vehicle comprising:
a) at least one wheel having a tire;
b) a velocity sensor for measuring an absolute vehicle velocity V_{abs.} of said vehicle;
c) a wheel sensing unit for measuring an angular velocity ω of a free-rolling wheel of said vehicle;
d) a processing unit in communication with said velocity sensor for receiving said absolute vehicle velocity V_{abs.} and in communication with said wheel sensing unit for receiving said angular velocity ω, wherein said processing unit further determines an effective radius R_{eff.} of said at least one wheel from said absolute vehicle velocity V_{abs.} and said angular velocity ω.

35. The vehicle of claim 34, wherein said velocity sensor comprises a global positioning unit and said vehicle velocity is a GPS velocity V_{GPS}.

36. The vehicle of claim 34, wherein said wheel sensing unit comprises an anti-lock braking system.

37. The vehicle of claim 34, further comprising an estimation module for obtaining an acceleration a of said vehicle by differencing said absolute vehicle velocity V_{abs.} and for obtaining a longitudinal stiffness Cₓ from said acceleration a and said effective radius R_{eff}.

38. The vehicle of claim 37, wherein said estimation module is a nonlinear estimation module.
